(19) United States
(12) Patent Application Publication
(10) Pub. No.: US 2021/0199631 A1
(43) Pub. Date: Jul. 1, 2021

(54) A GC/MS ARRANGEMENT AND MASS SPECTROMETER

(71) Applicant: Micromass UK Limited, Wilmslow (GB)

(72) Inventors: Alastair BOOTH, Glossop (GB); Alvin CHUA, Singapore (SG); Paul HOUGH, Whitegate Northwich (GB); Naigin KARIATT, Singapore (SG); Jake NGO, Singapore (SG); Richard TYLDESLEY-WORSTER, Wilmslow (GB); Arvind RANGAN, Singapore (SG)

(21) Appl. No.: 17/057,738

(22) PCT Filed: May 31, 2019
(86) PCT No.: PCT/GB2019/051491

§ 371 Date: Nov. 23, 2020

(30) Foreign Application Priority Data
Jun. 1, 2018 (SG) 10201804691Y
Jul. 2, 2018 (GB) 1810828.2

(51) Int. Cl. G01N 30/72; H01J 49/04; H01J 49/24

(52) U.S. Cl. CPC G01N 30/7206; H01J 49/24; H01J 49/0495; H01J 49/0422

(57) ABSTRACT

A GC/MS arrangement, comprising: a GC unit; an MS unit; a transfer line fluidly connecting the GC unit and the MS unit a carrier gas valve for selectively supplying carrier gas to the transfer line; at least one monitoring unit associated with the MS unit for monitoring at least one operational condition of the MS unit; and a controller connected to the at least one monitoring unit and carrier gas valve, configured to close the carrier gas valve when a predetermined operational event is detected by the at least one monitoring unit.

### BACKGROUND TO THE INVENTION

The present invention relates generally to mass spectrometers. More particularly, one aspect relates to a safety arrangement for a mass spectrometer and another aspect relates to a safety arrangement for a GC/MS arrangement.

Gas chromatography (GC) is a well-known analytical separation technique. A column containing a stationary phase is arranged in a GC oven. A sample is introduced into the column along with a mobile phase (carrier gas) and heated by the GC oven. The sample interacts with the stationary phase in the column and the components of the sample elute from the end of the column at different rates depending on their chemical and physical properties and affinity to the stationary phase.

It is known to interface the GC unit with a mass spectrometer (MS) unit—a so-called GC/MS arrangement—for analysis of the separated components of the sample. The GC and MS units may be discrete instruments and thus often have their own power supplies and control units, entirely separate from one another. In some instances, the GC and MS units are supplied by different manufacturers, with little or no integration therebetween.

The most common carrier gas is helium. For some applications, there is a desire to use hydrogen as a carrier gas, due to its lower cost (relative at least to helium), effectiveness and/or speed of separation. Hydrogen can be highly flammable and explosive, however, and care must be taken when using it in a GC/MS arrangement. The Lower Flammability/Explosive level (LFL/LEL) of hydrogen is particularly low (4%) and the Upper Flammability/Explosive level (UFL/UEL) of hydrogen is particularly high (75%), making it one of the most combustible gases.

Carrier gas, such as hydrogen, is introduced to the transfer line. It is known to provide a carrier gas safety arrangement comprising, for example, an electronic pressure controller. In the event of a loss of power and/or pressure to the GC unit, the pressure controller serves to isolate the carrier gas supply. However, where a GC unit and MS unit are controlled and/or powered independently of one another, it is feasible that the MS unit may fail (e.g. lose power and/or control), but the transfer line and GC unit may continue to deliver carrier gas to the MS unit, without knowledge of the failure of the MS unit. Consequently, the vacuum chamber of the MS unit, the backing (rotary) pump and/or the instrument chassis may become flooded with carrier gas. If the carrier gas is hydrogen, then over a prolonged period of time, a large build-up of hydrogen in the MS unit may create an explosive hazard. Whether the levels of hydrogen are explosive or flammable will depend on the concentration which has built up. Eventually, the concentration may be too high to pose a significant risk.

An operator, on approaching the GC/MS unit, may seek to reset or otherwise re-establish power to the MS unit, which may create a source of ignition for the hydrogen in the chamber of the MS unit, causing an explosion.

The present invention seeks to address at least some of the problems associated with a mass spectrometer.

### SUMMARY OF THE INVENTION

Accordingly, one aspect of the present invention provides a GC/MS arrangement, comprising:
a GC unit;
an MS unit;
a transfer line fluidly connecting the GC unit and the MS unit
a carrier gas valve for selectively supplying carrier gas to the transfer line;
at least one monitoring unit associated with the MS unit for monitoring at least one operational condition of the MS unit; and
a controller connected to the at least one monitoring unit and carrier gas valve, configured to close the carrier gas valve when a predetermined operational event is detected by the at least one monitoring unit.

In at least one embodiment, the carrier gas valve is a normally-closed solenoid valve.

In at least one embodiment, the predetermined operational event is the substantial loss of an operational vacuum in the MS unit.

In at least one embodiment, the MS unit comprises a vacuum pumping arrangement, and the monitoring unit is connected to the vacuum pumping arrangement.

In at least one embodiment, the operational condition is the status of the vacuum pumping arrangement.

In at least one embodiment, the predetermined operational event is that the vacuum pumping arrangement substantially loses power.

In at least one embodiment, the predetermined operational event is that the speed of at least one pump unit of the vacuum pumping arrangement drops below a predetermined threshold.

In at least one embodiment, the at least one monitoring unit includes or is connected to a pressure sensor in fluid communication with the chamber of the MS unit.

In at least one embodiment, the GC unit and MS unit are powered and/or controlled substantially independently of one another.

In at least one embodiment, the GC/MS arrangement further comprises a carrier gas supply in fluid connection with the carrier gas valve.

In at least one embodiment, the carrier gas is or includes a substantially flammable gas.

In at least one embodiment, the carrier gas is or includes hydrogen.

In at least one embodiment, the GC/MS arrangement further comprises an auxiliary gas valve fluidly for selectively supplying auxiliary gas to the transfer line, and wherein the controller is connected to the auxiliary gas valve and configured to close the auxiliary gas valve when a predetermined operational event is detected by the at least one monitoring unit.

Another aspect of the present invention provides a mass spectrometer comprising:
a vacuum pump, configured to generate a vacuum within a chamber of the mass spectrometer;
a system control unit connected to the vacuum pump;
a source assembly;
a source control unit connected to the source assembly, wherein the system control unit and the source control unit are connected for communication therebetween;
a pressure sensor to detect the pressure within said chamber of the mass spectrometer; and
an isolator connected to the pressure sensor, configured to isolate voltage or power to at least a part of the source assembly if the pressure sensor detects the pressure within said chamber of the mass spectrometer is above a predetermined level.

In at least one embodiment, the mass spectrometer further comprises a plurality of source components including at least one filament, a plurality of lenses and at least one heating element.

In at least one embodiment, the source control unit is configured to supply a voltage to at least one of the source components.

In at least one embodiment, the isolator is further configured to isolate power to the vacuum pump if the pressure sensor detects the pressure within said chamber of the mass spectrometer is above a predetermined level.

In at least one embodiment, the mass spectrometer further comprises a plurality of system components operatively connected to the system control unit, and the isolator is additionally configured to isolate voltage or power to at least some of said system components if the pressure sensor detects the pressure within said chamber of the mass spectrometer is above a predetermined level.

In at least one embodiment, the source control unit and system control unit are connected by a serial link.

In at least one embodiment, the pressure sensor is additionally connected to the source control unit and/or the system control unit.

In at least one embodiment, the system control unit is configured to monitor the vacuum pump and determine if the vacuum pump is operating within predetermined parameters, and to communicate the determination to the source control unit.

### DESCRIPTION OF THE DRAWINGS

Embodiments of the present invention will now be described, by way of non-limiting example only, with reference to the following figures in which:

FIG. 1 schematically illustrates a GC/MS arrangement embodying the present invention; and

FIG. 2 schematically illustrates a mass spectrometer embodying the present invention.

### DETAILED DESCRIPTION OF EMBODIMENTS OF THE INVENTION

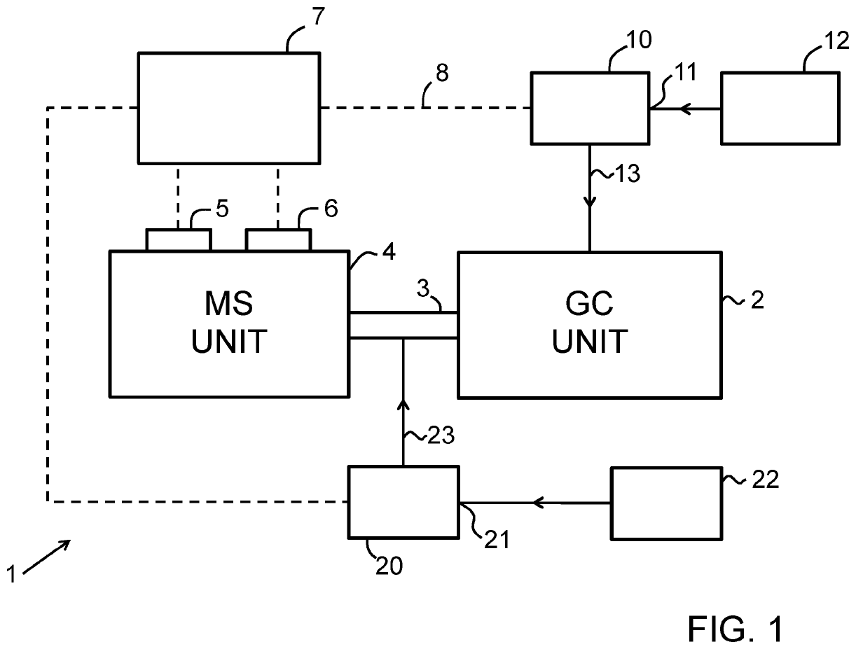

FIG. 1 schematically illustrates a GC/MS arrangement 1. The GC/MS arrangement 1 comprises a GC (gas chromatography) unit 2 and a MS (mass spectrometry) unit 4. The GC/MS arrangement 1 further comprises a transfer line 3. The transfer line 3 may extend from the body of the MS unit 4 and be selectively connectable to a corresponding outlet of the GC unit 2. Alternatively, the transfer line 3 may extend from the body of the GC unit 2 and be selectively connectable to a corresponding inlet of the MS unit 4. All that matters is that there is a fluid connection from the GC unit 2 to the MS unit 4, via the transfer line 3.

Further, the GC/MS arrangement 1 comprising a carrier gas valve 10 having a carrier gas inlet 11. The carrier gas valve 10 is configured to selectively supply carrier gas to the transfer line 3.

In the embodiment shown in FIG. 1, there is a carrier gas supply 12 fluidly connected to the carrier gas inlet 11, for the delivery of carrier gas to the carrier gas valve 10 via the carrier gas inlet 11. The carrier gas valve 10 is fluidly connected to the transfer line 3, either directly or via the GC unit 2. In FIG. 1, the carrier gas valve 10 is schematically illustrated as being connected to the GC unit 2, via the conduit 13, since the GC end of the transfer line 3 is arranged within the GC unit 2, in which the carrier gas and sample are introduced. This is not essential. The carrier gas valve 10 may be connected to (or form part of) the GC unit 2 and/or a corresponding port on the transfer line 3.

In use, the MS unit 4 is configured to receive carrier gas from the GC unit 2 via the transfer line 3. The carrier gas may or may not include a sample introduced by the GC unit 2.

The GC/MS arrangement 1 further comprises at least one monitoring unit 5, 6 associated with the MS unit 4 for monitoring at least one operational condition of the MS unit 4. In the embodiment shown, there are two monitoring units 5, 6. The first monitoring unit 5 may be connected to, associated with, or interfaced with a vacuum pump (not shown) of the MS unit 4. The second monitoring unit 6 may comprise a pressure sensor. It is not essential to have both the monitoring units 5, 6. There may be only one monitoring unit 5, 6. There may be more than two monitoring units 5, 6. In at least one embodiment, the monitoring units are chosen so as to monitor the parameter(s) which are deemed of importance to accurately determine the operational condition of the MS unit.

The GC/MS arrangement 1 further comprises a controller 7 connected to the at least one monitoring unit 5, 6 and to the carrier gas valve 10, and is configured to close the carrier gas valve 10 in the event that a predetermined operational event is detected by the at least one monitoring unit 5, 6.

The carrier gas valve 10 may comprise a normally-closed solenoid valve. Accordingly, the carrier gas valve 10 may substantially prevent (or limit) the passage of any carrier gas therethrough unless a contact closure (and/or other control signal) is applied to the carrier gas valve 10. In the event of a loss of power to and/or a malfunction of the controller, the carrier gas valve 10 is “failsafe” and will act to isolate a carrier gas supply 12.

In certain embodiments, the predetermined operational event is one which indicates that the MS unit 4 is not operating within a predetermined operational range. For example, one predetermined operational event may be the loss of an operational vacuum in the chamber of the MS unit 4. In one embodiment, the monitoring unit 5 is associated with the vacuum control system or components of the MS unit 4. For example, the control system of the MS unit 4 may independently be monitoring the vacuum status of the MS unit 4, and the control unit of the MS unit 4 may comprise an interface by which the system status can be interrogated by an external monitoring unit 5. It is known for the control system of an MS unit 4 to output a “vac_ok” signal, when there is deemed to be an operational vacuum in the MS unit 4. In certain embodiments, the monitoring unit 5 is operatively connected to receive the “vac_ok” signal. In response, the controller 7 can send a signal to the carrier gas valve 10 to open the valve to allow the passage of carrier gas into the transfer line 3 (via the GC unit). In the event that the speed of the vacuum pump (e.g. turbo pump) of the MS unit 4 drops below a certain level (for example 80% of its optimal operating speed), which may be indicative of a power cut or mechanical failure of the pump, the control system of the MS unit 4 may turn off or rescind the “vac_ok” signal which, in turn, would cause the controller 7 to turn off the carrier gas valve 10. Alternatively or additionally, the monitoring unit 5 may, itself, assess the speed of the turbo pump and make its own determination as to its operational condition.

In one embodiment, the controller is configured to turn off the carrier gas valve 10 when either the ‘vac_ok’ signal is lost, terminated or rescinded or when the speed of the vacuum pump (e.g. turbo pump) of the MS unit 4 drops below a predetermined level.

Alternatively or additionally, the monitoring unit 6 may comprise a pressure sensor 6 in fluid communication with the vacuum chamber of the MS unit 4. The pressure sensor 6 may independently determine the presence of an operational vacuum in the MS unit 4, which determination can be utilized by the controller to decide whether to isolate the carrier gas valve 10. The controller 7 may receive inputs from multiple monitoring units 5, 6. For example, the controller 7 may receive both a ‘vac_ok’ signal from the MS unit 4 and an independent measurement of the vacuum from the pressure sensor 6. In one embodiment, the controller 7 may require that both signals verify the existence of an operational vacuum before opening the carrier gas valve 10. The controller 7 may be configured to close the carrier gas valve 7 in the event that at least one of the MS unit 4 or independent pressure sensor indicates a loss of operational vacuum.

As noted above, it is known for a GC unit 2 and MS unit 4 to be powered and/or controlled substantially independently of one another. A benefit of the claimed invention is that the GC/MS arrangement 1 establishes a control interlock between the GC unit 2 and the MS unit 4. A GC/MS arrangement 1 embodying the present invention may be supplemental to existing safety systems in one or both of the GC unit 2 and MS unit 4. A benefit of embodiments of the present invention is that in the event that the MS unit 4 loses power and/or develops a operational fault, but yet the power supply to the GC unit 2 remains, the arrangement of the present invention will serve to isolate the carrier gas supply and prevent carrier gas from potentially flooding the chamber of the MS unit 4.

In addition, the controller 7 of at least one embodiment of the present invention may also send a signal to the GC unit 2 informing the corresponding control system of a failure of the MS unit 4, such that the GC unit 2 may additionally be shut down or isolated, or some other action taken.

FIG. 1 further illustrates an auxiliary gas valve 20 configured to selectively supply auxiliary gas to the transfer line 3, for example a chemical ionisation reagent gas, which may also be flammable and/or toxic. The transfer line 3 may include a separate conduit within the transfer line 3 for delivering the auxiliary gas to the tip of the transfer line 3, without communicating or mixing with the carrier gas whilst in the transfer line 3. The GC/MS arrangement 1 may further comprise an auxiliary gas supply 22 in fluid communication with an auxiliary gas supply inlet 21. An auxiliary gas conduit 23 is shown in FIG. 1 as being fluidly connected directly between the auxiliary gas valve 20 and the transfer line 3. The conduit 23 may interface with a corresponding port or inlet on the transfer line 3. The auxiliary gas may be a chemical ionization gas, for example methane, isobutene and ammonia. Additionally, the controller 7 is connected to the auxiliary gas valve 20 and may be configured to close the auxiliary gas valve 20 when a predetermined operational event is detected by the at least one monitoring unit 5, 6. A benefit of such an arrangement is that the GC/MS arrangement 1 serves to isolate at least a carrier gas supply 12 and at least one auxiliary gas supply 22 from flooding the chamber of the MS unit 4.

In at least one embodiment, the controller 7 is configured to close the carrier gas valve 10 and the auxiliary gas valve 20 substantially simultaneously. Although the carrier gas valve 10 and the auxiliary gas valve 20 are depicted in FIG. 1 as being discrete valves, this is not essential. In at least one embodiment, they may be provided within the same valve unit. They may be arranged in a double pole single throw (DPST) configuration, such that the carrier gas valve 10 and the auxiliary gas valve 20 are configured to open and close substantially simultaneously. Such a combined valve unit may comprise a single input from the controller to operate the valves 10, 20.

The dotted lines in the schematic illustration in FIG. 1 are to illustrate an operational (e.g. electrical/control) link, e.g. between the controller 7, the carrier gas valve 10 and the at least one monitoring unit 5, 6. The solid lines are to illustrate a fluid connection, e.g. between the carrier gas supply 12 and the carrier gas valve 10, between the carrier gas valve 10 and the transfer line 3, between the auxiliary gas supply 22 and the auxiliary gas valve 20, and between the auxiliary gas valve 20 and the transfer line 3.

The pressure of the carrier gas supply may be in the region of 600-1000 kPa (6-10 bar). The carrier gas valve 10 may have a stand-off pressure of 1000 kPa (10 bar) and a leak rate of around 2 ml/min. In one embodiment, the pressure controller of the GC unit 2 may be configured to close when the pressure of a fluid entering the GC unit 2 drops below 400 kPa (4 bar). When the GC/MS arrangement 1 is operating within its optimal range, the flow of carrier gas into the MS unit 4 may be in the order of 1-2 ml/min. It will be noted that such a flow rate may be in the same range as the leak rate of the carrier gas valve 10. In certain embodiments of the present invention, the GC unit 2 comprises a flow controller which is configured to purge a septum of the GC unit 2. The flow rate of a purging operation may be in the order of 8-30 ml/min. Consequently, since the flow rate of the purging operation is higher than the leak rate of the carrier gas valve 10, this will serve to vent any carrier gas leaking through the carrier gas valve 10. When the pressure of the fluid entering the GC unit 2 drops below 400 kPa (4 bar), the pressure controller of the GC unit 2 will close, preventing carrier gas entering into MS unit 4. In other embodiments, the carrier gas valve 10 may have a minimal or no leak rate.

A benefit of the GC/MS arrangement(s) described herein is that, if hydrogen or another flammable gas is used as the carrier gas, the risk of the MS unit or associated pump being flooded with hydrogen is reduced or avoided, which could otherwise cause an explosion. Nevertheless, even if a less or non-flammable carrier gas is used, preventing the chamber of the MS unit from being flooded avoids wasting the carrier and/or auxiliary gases, and reduces the need for the chamber to be cleaned or purged before it can be recommissioned for use.

Generally speaking, a mass spectrometer comprises an ion source, a mass analyser and a detector, all arranged in a vacuum chamber. There are different types of ion sources. The ion source of a mass spectrometer of the type referred to in this specification includes an inner source assembly and an outer source assembly. The incoming components (GC eluent) of the sample from the GC unit are first introduced into the inner source assembly. Here, they are ionised by an ion source, upon colliding with electrons emitted by one or more filaments and are then emitted towards the outer source assembly which guides the ions through a series of ion lenses (extraction lens stack) towards an analyser and detector of the mass spectrometer. The extraction lens stack is typically secured to the analyser housing. In use, the inner source assembly mates with the outer source assembly.

There is a need, in use, to remove and clean/replace various components of the mass spectrometer, including the inner and/or outer housing. Both the inner and outer housing comprise various components to which an electrical and/or control signal is supplied in use. To aid in the disassembly of the mass spectrometer, the inner and/or outer housing assembly may comprise a local source control unit (e.g. a PCB), which may be secured to the inner and/or outer housing assembly. The various components of the inner/outer source are connected to the source control unit. An electrical/control connection is then made between the source control unit and a main system control unit of the mass spectrometer. The electrical/control connection between the source control unit and the system control until may include a single connection terminal, which may be secured/detached in a single operation. This avoids the need to make/break individual connections between the system control unit and each of the components of the inner and/or outer source assembly in use, which is time consuming and error prone.

The system control unit oversees the operation of the mass spectrometer, and so monitors and controls the inner and/or outer source assembly in addition to any other system components (e.g. vacuum pump). The system control unit may only operate the mass spectrometer if it receives a positive indication from the source control unit that the inner and/or outer source components are operational and functioning within predetermined operational parameters. Likewise, the source control unit may only operate the inner and/or outer source assembly components if it receives a positive indication from the system control unit that it is safe to do so.

There may be a serial communication link between the system control unit and the source control unit. Each of the system control unit and source control unit may comprise a suitable communication unit which is operable to receive data from the associated components and convert it into serial data for communication to the other of the source control unit and system control unit.

The system control unit may control a vacuum pump of the mass spectrometer. When the system control unit determines that the vacuum pump is operating correctly and has generated an operational vacuum, the system control unit may output a “vac_ok” signal. This may be received by the source control unit which may, in response, operate the inner and/or outer source components. Conversely, if the system control unit indicates to the source control unit that the operational vacuum has not been achieved or the chamber has vented, then the source control unit may isolate voltage or power to some or all of the inner and/or outer source components. This ensures the safe operation of the mass spectrometer. By isolating voltage or power to the inner and/or outer source components when there is no operational vacuum, damage to the components is prevented, and the risk of injury to an operator is reduced.

However, it is possible that the communication link between the system control unit and source control unit may be lost or become corrupted. Consequently, the source control unit may be caused to operate some or all of the inner and/or outer source components, unaware whether there is an operational vacuum. In some arrangements, the system control board may report the status of the vacuum to the source control unit at predetermined intervals. After receiving a ‘vac_ok’ signal from the system control unit, the source control may be configured to continue to operate until it receives an indication that an operational vacuum has been lost. A failure to receive that indication, due to a loss of communication, may result in the source control unit continuing to supply voltage or power to the source components. Alternatively or additionally, the vacuum pump and/or main control unit may malfunction, causing a false indication to be sent to the source control unit that an operational vacuum is present (a false positive) or a false indication that an operational vacuum has been lost (a false negative).

The communication link between the system control unit and the source control unit may represent a single point of failure in the mass spectrometer system. Another aspect of the present invention seeks to address the problem.

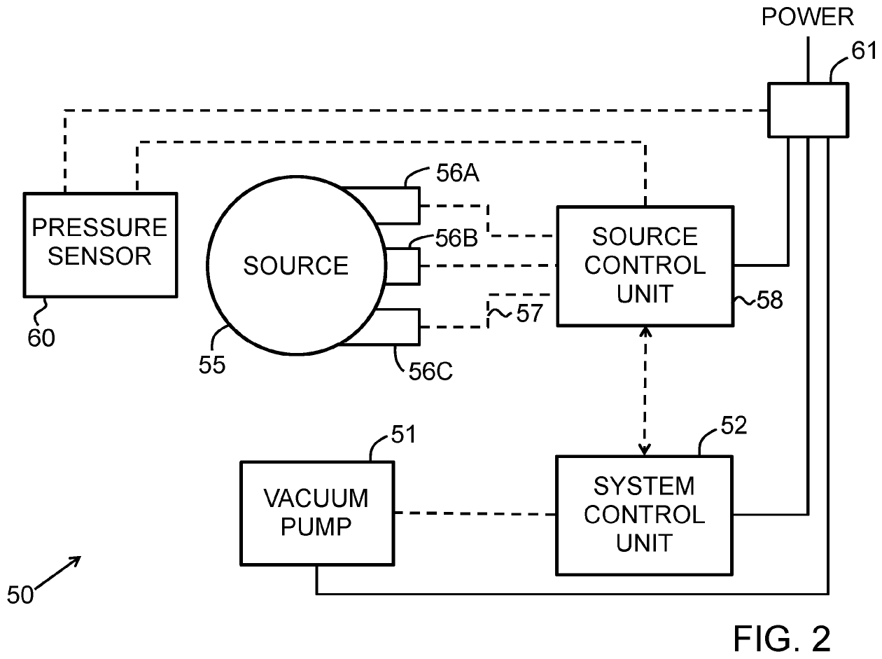

FIG. 2 schematically illustrates a mass spectrometer 50 according to at least one embodiment of another aspect of the present invention, comprising a vacuum pump 51 configured to generate a vacuum within a chamber of the mass spectrometer 50. The mass spectrometer 50 further comprises a system control unit 52 connected to the vacuum pump 51. The system control unit 52, in combination with the source control unit 58, oversees the operation of the mass spectrometer 50.

The mass spectrometer 50 further comprises a source assembly 55. The source assembly 55 may comprise various components, some or all of which require control, voltage or power in use to operate. Such components include but are not limited to at least one filament 56A, at least one lens 56B and at least one heater 56C. The source assembly 55 may comprise an inner and outer source.

The at least one filament 56A is arranged adjacent an ionisation chamber within the inner source assembly. Electrons emitted by the filament(s) interact with the sample molecules (introduced from the transfer line 3) which serve to ionise them. The at least one heater 56C may comprise a heating element within a heater block of the outer source assembly. In use, the heater block serves to heat the ionisation chamber of the inner source assembly. The at least one lens 56B may form part of the outer source assembly. In one embodiment, there is a plurality of lenses 56B arranged in a stack, which serve to guide the ionised analyte molecules from the ionisation chamber adjacent the heater block into a mass spectrometer analyser. In use, the at least one lens 56B is electrically charged. They may each be held at different voltages.

The mass spectrometer 50 further comprises a source control unit 58 connected to the source assembly 55. More specifically, the source control unit 58 is connected to the plurality of components 56A, 56B, 56C of the source assembly 55 to supply voltage or power and/or control signals thereto, and to monitor their status. A plurality of wires 57 may be connected between each of the components 56A, 56B, 56C and the source control unit 58.

The source control unit 58 and the system control unit 52 are connected to one another for communication therebetween. The connection may be via a serial link.

The mass spectrometer 50 further comprises a pressure sensor 60. The pressure sensor 60 is configured to detect the pressure within the chamber of the mass spectrometer 50. A power isolator 61 is connected to the pressure sensor 60 and configured to isolate voltage or power to at least part of the source assembly 55 if the pressure sensor 60 detects the pressure within said chamber of the mass spectrometer is above a predetermined level (i.e. there is no operational vacuum).

In one embodiment, the output of the pressure sensor 60 may comprise the absolute pressure measured by the pressure sensor 60, and the power isolator 61 is configured to interpret whether the pressure measured by the pressure sensor 60 is above a predetermined level (i.e. no operational vacuum). In another embodiment, the pressure sensor 60 itself may comprise a processor which assesses whether the pressure is above a predetermined level. The processor may then send a binary signal to the power isolator 61, to indicate either that the pressure is above a predetermined level (i.e. no operational vacuum), or at or below a predetermined level (i.e. operational vacuum). In one embodiment, the pressure sensor 60 may output a voltage which is indicative of either the absolute pressure measured, or whether the pressure measured is above or below a predetermined level. For example, the pressure sensor 60 may output a voltage of +5V if an operational vacuum is measured. A voltage of 0V may be output if there is not deemed to be an operational vacuum.

A benefit of this arrangement is that if the system control unit 52 does not communicate with the source control unit 58, the pressure sensor 60 is still able to communicate, via a dedicated connection, with the power isolator 61 to isolate voltage or power from the components of the source assembly 55 in the event of a loss of operational vacuum.

In addition to isolating voltage or power to at least part of the source assembly 55, the power isolator 61 may be further configured to isolate power to the vacuum pump 51 if the pressure sensor 60 detects the pressure within said chamber of the mass spectrometer 50 is above a predetermined level. Alternatively or additionally, the power isolator 61 may be further configured to isolate voltage or power to at least some of the other system components if the pressure sensor 60 detects the pressure within said chamber of the mass spectrometer 50 is above a predetermined level.

These features provide an override arrangement when the vacuum pump 51 and/or the system control unit 52 is either unable to determine, or wrongly characterises, the operational status of the vacuum pump 51 and/or system components.

The pressure sensor 60 may separately be connected to the source control unit 58 and/or the system control unit 52. An advantage of a dedicated connection between the pressure sensor 60 and the power isolator 61 is that it is not reliant on the correct operation of the source control unit 58 and/or system control unit 52 or the communication therebetween in order to detect, and respond to, a loss of operational vacuum.

One or both of the source control unit 58 and system control unit 52 may comprise a printed circuit board assembly (PCBA).

The MS unit 4 of the arrangement illustrated in FIG. 1 may comprise the mass spectrometer 50 of FIG. 2.

When used in this specification and claims, the terms “comprises” and “comprising” and variations thereof mean that the specified features, steps or integers are included. The terms are not to be interpreted to exclude the presence of other features, steps or components. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Representative Features

A1 A GC/MS arrangement, comprising:
a GC unit;
an MS unit;
a transfer line fluidly connecting the GC unit and the MS unit
a carrier gas valve for selectively supplying carrier gas to the transfer line;
at least one monitoring unit associated with the MS unit for monitoring at least one operational condition of the MS unit; and
a controller connected to the at least one monitoring unit and carrier gas valve, configured to close the carrier gas valve when a predetermined operational event is detected by the at least one monitoring unit.

A2. A GC/MS arrangement according to clause A1, wherein the carrier gas valve is a normally-closed solenoid valve.

A3. A GC/MS arrangement according to any of clauses A1 and A2, wherein the predetermined operational event is the substantial loss of an operational vacuum in the MS unit.

A4. A GC/MS arrangement according to any of clauses A1 to A3, wherein the MS unit comprises a vacuum pumping arrangement, and the monitoring unit is connected to the vacuum pumping arrangement.

A5. A GC/MS arrangement according to clause A4, wherein the operational condition is the status of the vacuum pumping arrangement.

A6. A GC/MS arrangement according to clause A5, wherein the predetermined operational event is that the vacuum pumping arrangement substantially loses power.

A7. A GC/MS arrangement according to clause A5 or A6, wherein the predetermined operational event is that the speed of at least one pump unit of the vacuum pumping arrangement drops below a predetermined threshold.

A8. A GC/MS arrangement according to any of clauses A1 to A7, wherein the at least one monitoring unit includes or is connected to a pressure sensor in fluid communication with the chamber of the MS unit.

Representative Features

A9. A GC/MS arrangement according to any of clauses A1 to A8, wherein the GC unit and MS unit are powered and/or controlled substantially independently of one another.

A10. A GC/MS arrangement according to any of clauses A1 to A9, further comprising a carrier gas supply in fluid connection with the carrier gas valve.

A11. A GC/MS arrangement according to clause A10, wherein the carrier gas is or includes a substantially flammable gas.

A12. A GC/MS arrangement according to clause A11, wherein the carrier gas is or includes hydrogen.

A13. A GC/MS arrangement according to any of clauses A1 to 12, further comprising an auxiliary gas valve fluidly for selectively supplying auxiliary gas to the transfer line, and wherein the controller is connected to the auxiliary gas valve and configured to close the auxiliary gas valve when a predetermined operational event is detected by the at least one monitoring unit.

B1 A mass spectrometer comprising:
a vacuum pump, configured to generate a vacuum within a chamber of the mass spectrometer;
a system control unit connected to the vacuum pump;
a source assembly;
a source control unit connected to the source assembly, wherein the system control unit and the source control unit are connected for communication therebetween;
a pressure sensor to detect the pressure within said chamber of the mass spectrometer; and
an isolator connected to the pressure sensor, configured to isolate voltage or power to at least a part of the source assembly if the pressure sensor detects the pressure within said chamber of the mass spectrometer is above a predetermined level.

B2. A mass spectrometer according to clause B1, further comprising a plurality of source components including at least one filament, a plurality of lenses and at least one heating element.

Representative Features

B3. A mass spectrometer according to clause B2, wherein the source control unit is configured to supply a voltage to at least one of the source components.

B4. A mass spectrometer according to any of clauses B1 to B3, wherein the isolator is further configured to isolate power to the vacuum pump if the pressure sensor detects the pressure within said chamber of the mass spectrometer is above a predetermined level.

B5. A mass spectrometer according to any of clauses B1 to B4, further comprising a plurality of system components operatively connected to the system control unit, and the isolator is additionally configured to isolate voltage or power to at least some of said system components if the pressure sensor detects the pressure within said chamber of the mass spectrometer is above a predetermined level.

B6. A mass spectrometer according to any of clauses B1 to B5, wherein the source control unit and system control unit are connected by a serial link.

B7. A mass spectrometer according to any of clauses B1 to B6, wherein the pressure sensor is additionally connected to the source control unit and/or the system control unit.

B8. A mass spectrometer according to any of clauses B1 to B7, wherein the system control unit is configured to monitor the vacuum pump and determine if the vacuum pump is operating within predetermined parameters, and to communicate the determination to the source control unit.

1. A gas chromatography(GM)/mass spectrometer (MS) arrangement, comprising:
a GC unit;
an MS unit including a vacuum pumping arrangement;
a transfer line fluidly connecting the GC unit and the MS unit
a carrier gas valve for selectively supplying carrier gas to the transfer line;
at least one monitoring unit connected to the vacuum pumping arrangement for monitoring the status of the vacuum pumping arrangement; and
a controller connected to the at least one monitoring unit and carrier gas valve, configured to close the carrier gas valve when the at least one monitoring unit detects a substantial loss of an operational vacuum in the MS unit.

2. A GC/MS arrangement according to claim 1, wherein the carrier gas valve is a normally-closed solenoid valve.

3-5. (canceled)

6. A GC/MS arrangement according to claim 1, wherein the controller is configured to close the carrier gas valve when the at least one monitoring unit detects that the vacuum pumping arrangement substantially loses power.

7. A GC/MS arrangement according to claim 1, wherein the controller is configured to close the carrier gas valve when the at least one monitoring unit detects that the speed of at least one pump unit of the vacuum pumping arrangement drops below a predetermined threshold.

8. A GC/MS arrangement according to claim 1, wherein the at least one monitoring unit includes or is connected to a pressure sensor in fluid communication with a chamber of the MS unit.

9. A GC/MS arrangement according to claim 1, wherein the GC unit and MS unit are powered and/or controlled substantially independently of one another.

10. A GC/MS arrangement according to claim 1, further comprising a carrier gas supply in fluid connection with the carrier gas valve.

11. A GC/MS arrangement according to claim 10, wherein the carrier gas is or includes a substantially flammable gas.

12. A GC/MS arrangement according to claim 11, wherein the carrier gas is or includes hydrogen.

13. A GC/MS arrangement according to claim 1, further comprising an auxiliary gas valve fluidly for selectively supplying auxiliary gas to the transfer line, and wherein the controller is connected to the auxiliary gas valve and configured to close the auxiliary gas valve when a predetermined operational event is detected by the at least one monitoring unit.

14. A mass spectrometer comprising:
a vacuum pump, configured to generate a vacuum within a chamber of a mass spectrometer;
a system control unit connected to the vacuum pump;
a source assembly;
a source control unit connected to the source assembly, wherein the system control unit and the source control unit are connected for communication therebetween;
a pressure sensor to detect a pressure within the chamber of the mass spectrometer; and
an isolator connected to the pressure sensor, configured to isolate voltage or power to at least a part of the source assembly if the pressure sensor detects the pressure within the chamber of the mass spectrometer is above a predetermined level.

15. A mass spectrometer according to claim 14, further comprising a plurality of source components including at least one filament, a plurality of lenses and at least one heating element.

16. A mass spectrometer according to claim 15, wherein the source control unit is configured to supply a voltage to at least one of the source components.

17. A mass spectrometer according to claim 14, wherein the isolator is further configured to isolate power to the vacuum pump if the pressure sensor detects the pressure within the chamber of the mass spectrometer is above a predetermined level.

18. A mass spectrometer according to claim 14, further comprising a plurality of system components operatively connected to the system control unit, and the isolator is additionally configured to isolate voltage or power to at least some of said system components if the pressure sensor detects the pressure within the chamber of the mass spectrometer is above a predetermined level.

19. A mass spectrometer according to claim 14, wherein the source control unit and system control unit are connected by a serial link.

20. A mass spectrometer according to claim 14, wherein the pressure sensor is additionally connected to the source control unit and/or the system control unit.

21. A mass spectrometer according to claim 14, wherein the system control unit is configured to monitor the vacuum pump and determine if the vacuum pump is operating within predetermined parameters, and to communicate the determination to the source control unit.
